(19) United States
(12) Patent Application Publication
(10) Pub. No.: US 2011/0266726 A1
(43) Pub. Date: Nov. 3, 2011

(54) GAS TURBINE EXHAUST AS HOT BLAST FOR A BLAST FURNACE

(75) Inventors: Richard Anthony DePuy, Burnt Hills, NY (US); Robert Thomas Thatcher, Greer, SC (US)

(73) Assignee: GENERAL ELECTRIC COMPANY, Schenectady, NY (US)

(21) Appl. No.: 12/772,656

(22) Filed: May 3, 2010

(51) Int. Cl. C21B 9/00; C21B 7/00; F02C 6/04

(52) U.S. Cl. 266/140; 60/784

(57) ABSTRACT

In certain exemplary embodiments, a system includes a gas turbine system having a turbine, combustor, and a compressor. The system also includes an output flow path from the gas turbine system. The system further includes a blast furnace coupled to the output flow path, wherein output flow path is configured to deliver heated air or exhaust gas from the gas turbine system directly to the blast furnace as a blast heat source.

### BACKGROUND OF THE INVENTION

The subject matter disclosed herein relates to blast furnaces and, more specifically, to systems and methods for using exhaust gas and hot extraction air from gas turbines as hot blast for a blast furnace.

Blast furnaces are frequently used in the production of metal iron in, for example, steel mill plants. Hot blast (e.g., air heated to a very high temperature) is used to reduce iron oxide into metal iron in the blast furnaces. The hot blast is typically generated by hot stoves, which heat the air before introducing the hot blast into the blast furnaces. However, hot stoves have a tendency to foul over time.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine system having a turbine, combustor, and a compressor. The system also includes an output flow path from the gas turbine system. The system further includes a blast furnace coupled to the output flow path, wherein output flow path is configured to deliver heated air or exhaust gas from the gas turbine system directly to the blast furnace as a blast heat source.

In a second embodiment, a system includes a gas turbine system having a turbine, combustor, and a compressor. The system also includes a blast furnace configured to receive exhaust gas from the turbine of the gas turbine system as a first blast heat source.

In a third embodiment, a system includes a fuel system configured to produce a fuel. The system also includes a compressor configured to produce compressed air. The system further includes a combustor configured to combust the compressed air from the compressor and the fuel from the fuel system. In addition, the system includes a blast furnace configured to receive exhaust gas from the combustor as a blast heat source.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic flow diagram of an exemplary embodiment of a combined cycle power generation system having a gas turbine, a steam turbine, a heat recovery steam generation (HRSG) system, and a fuel system;

FIG. 2 is a process flow diagram of an exemplary embodiment of a steel mill which may generate fuel sources for use within the fuel system;

FIG. 3 is a schematic flow diagram of an exemplary embodiment of a blast furnace of FIG. 2;

FIG. 4 is a schematic flow diagram of an exemplary embodiment of the blast furnace of FIG. 2 configured to receive heated exhaust gas directly from the turbine of the gas turbine of FIG. 1 as hot blast;

FIG. 5 is a schematic flow diagram of an exemplary embodiment of the blast furnace of FIG. 2 configured to receive heated exhaust gas directly from the turbine of the gas turbine of FIG. 1 and hot extraction air directly from the compressor of the gas turbine of FIG. 1 as hot blast;

FIG. 6 is a schematic flow diagram of an exemplary embodiment of the blast furnace of FIG. 2 configured to receive hot blast from the hot stove, wherein the hot stove is configured to produce the hot blast from heated exhaust gas received from the turbine of the gas turbine of FIG. 1;

FIG. 7 is a schematic flow diagram of an exemplary embodiment of the blast furnace of FIG. 2 configured to receive hot blast from the hot stove, wherein the hot stove is configured to produce the hot blast from heated exhaust gas received from the turbine of the gas turbine of FIG. 1 and hot extraction air received from the compressor of the gas turbine of FIG. 1;

FIG. 8 is a schematic flow diagram of an exemplary embodiment of the blast furnace of FIG. 2 configured to receive hot blast from the hot stove, wherein the hot stove is configured to produce the hot blast from heated exhaust gas received from the turbine of the gas turbine of FIG. 1 and supplemental ambient air;

FIG. 9 is a schematic flow diagram of an exemplary embodiment of the blast furnace of FIG. 2 configured to receive hot blast from the hot stove, wherein the hot stove is configured to produce the hot blast from heated exhaust gas received from the turbine of the gas turbine of FIG. 1, hot extraction air received from the compressor of the gas turbine of FIG. 1, and supplemental ambient air;

FIG. 10 is a schematic flow diagram of an exemplary embodiment of the blast furnace of FIG. 2 configured to receive heated exhaust gas directly from the turbine of the gas turbine of FIG. 1 as hot blast, wherein the combustor of the gas turbine uses fuel from the steel mill of FIG. 2;

FIG. 11 is a schematic flow diagram of an exemplary embodiment of a compressor and a combustor configured to produce hot blast for use in the blast furnace of FIG. 2; and

FIG. 12 is a schematic flow diagram of an exemplary embodiment of the blast furnace of FIG. 2 configured to receive hot extraction air from the compressor of the gas turbine of FIG. 1 and through an expander.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods for using exhaust gas and hot extraction air from gas turbines as hot blast for a blast furnace. In certain exemplary embodiments, heated exhaust gas from a turbine of a gas turbine system may be used as a source of hot blast in the blast furnace. In other exemplary embodiments, the heated exhaust gas from the turbine of the gas turbine system and hot extraction air from the compressor of the gas turbine engine may both be used as a source of hot blast in the blast furnace. In certain exemplary embodiments, the heated exhaust gas and the hot extraction air may be delivered directly to the blast furnace, without first being directed into a hot stove. However, in other exemplary embodiments, the heated exhaust gas and the hot extraction air may be directed into a hot stove before being used as hot blast in the blast furnace. By using the heated exhaust gas from the turbine of the gas turbine system and the hot extraction gas from the compressor of the gas turbine system as hot blast, the load on a hot stove associated with the blast furnace may be reduced or even eliminated, thereby reducing the adverse affects of using hot stoves described above.

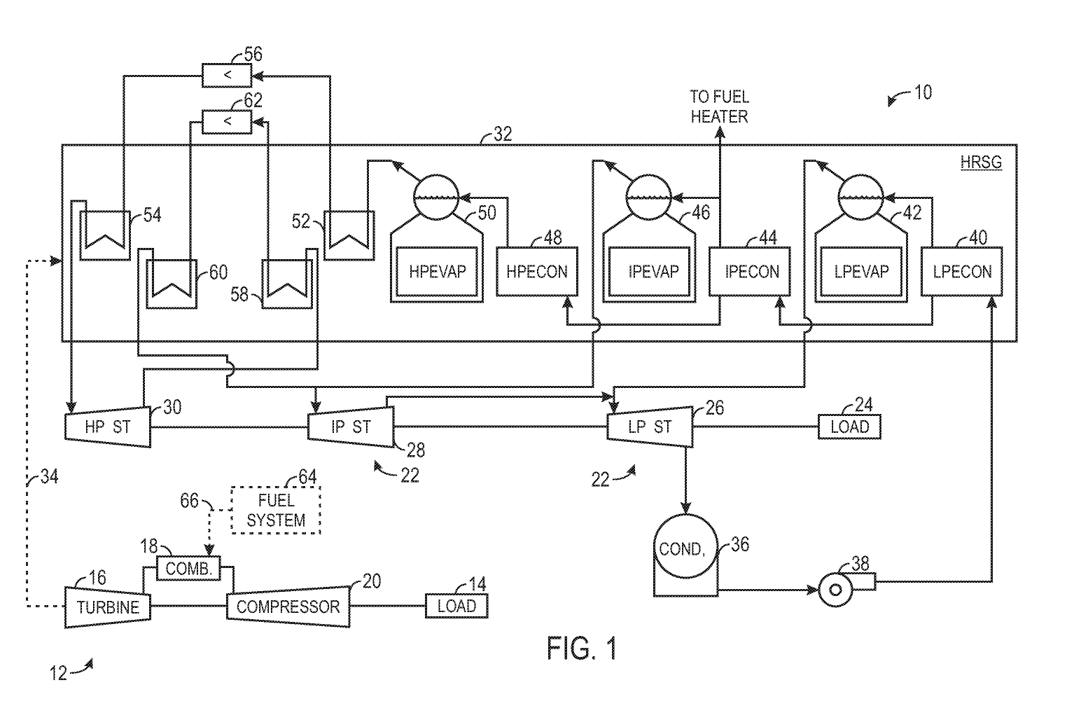

FIG. 1 is a schematic flow diagram of an exemplary embodiment of a combined cycle power generation system 10 having a gas turbine, a steam turbine, a heat recovery steam generation (HRSG) system, and a fuel system. As described in greater detail below, the fuel system may be configured to deliver fuel to the gas turbine by blending multiple by-product gases, e.g., blast furnace gas and coke oven gas from a steel mill.

The system 10 may include a gas turbine 12 for driving a first load 14. The first load 14 may, for instance, be an electrical generator for producing electrical power. The gas turbine 12 may include a turbine 16, a combustor or combustion chamber 18, and a compressor 20. The system 10 may also include a steam turbine 22 for driving a second load 24. The second load 24 may also be an electrical generator for generating electrical power. However, both the first and second loads 14, 24 may be other types of loads capable of being driven by the gas turbine 12 and steam turbine 22. In addition, although the gas turbine 12 and steam turbine 22 may drive separate loads 14 and 24, as shown in the illustrated embodiment, the gas turbine 12 and steam turbine 22 may also be utilized in tandem to drive a single load via a single shaft. In the illustrated embodiment, the steam turbine 22 may include one low-pressure section 26 (LP ST), one intermediate-pressure section 28 (IP ST), and one high-pressure section 30 (HP ST). However, the specific configuration of the steam turbine 22, as well as the gas turbine 12, may be implementation-specific and may include any combination of sections.

The system 10 may also include a multi-stage HRSG 32. The components of the HRSG 32 in the illustrated embodiment are a simplified depiction of the HRSG 32 and are not intended to be limiting. Rather, the illustrated HRSG 32 is shown to convey the general operation of such HRSG systems. Heated exhaust gas 34 from the gas turbine 12 may be transported into the HRSG 32 and used to heat steam used to power the steam turbine 22. Exhaust from the low-pressure section 26 of the steam turbine 22 may be directed into a condenser 36. Condensate from the condenser 36 may, in turn, be directed into a low-pressure section of the HRSG 32 with the aid of a condensate pump 38.

The condensate may then flow through a low-pressure economizer 40 (LPECON), a device configured to heat feedwater with gases, which may be used to heat the condensate. From the low-pressure economizer 40, a portion of the condensate may be directed into a low-pressure evaporator 42 (LPEVAP) while the rest may be pumped toward an intermediate-pressure economizer 44 (IPECON). Steam from the low-pressure evaporator 42 may be returned to the low-pressure section 26 of the steam turbine 22. Likewise, from the intermediate-pressure economizer 44, a portion of the condensate may be directed into an intermediate-pressure evaporator 46 (IPEVAP) while the rest may be pumped toward a high-pressure economizer 48 (HPECON). In addition, steam from the intermediate-pressure economizer 44 may be sent to a fuel heater (not shown) where the steam may be used to heat fuel for use in the combustion chamber 18 of the gas turbine 12. Steam from the intermediate-pressure evaporator 46 may be sent to the intermediate-pressure section 28 of the steam turbine 22. Again, the connections between the economizers, evaporators, and the steam turbine 22 may vary across implementations as the illustrated embodiment is merely illustrative of the general operation of an HRSG system that may employ unique aspects of the present embodiments.

Finally, condensate from the high-pressure economizer 48 may be directed into a high-pressure evaporator 50 (HPEVAP). Steam exiting the high-pressure evaporator 50 may be directed into a primary high-pressure superheater 52 and a finishing high-pressure superheater 54, where the steam is superheated and eventually sent to the high-pressure section 30 of the steam turbine 22. Exhaust from the high-pressure section 30 of the steam turbine 22 may, in turn, be directed into the intermediate-pressure section 28 of the steam turbine 22. Exhaust from the intermediate-pressure section 28 of the steam turbine 22 may be directed into the low-pressure section 26 of the steam turbine 22.

An inter-stage attemperator 56 may be located in between the primary high-pressure superheater 52 and the finishing high-pressure superheater 54. The inter-stage attemperator 56 may allow for more robust control of the exhaust temperature of steam from the finishing high-pressure superheater 54. Specifically, the inter-stage attemperator 56 may be configured to control the temperature of steam exiting the finishing high-pressure superheater 54 by injecting cooler feedwater spray into the superheated steam upstream of the finishing high-pressure superheater 54 whenever the exhaust temperature of the steam exiting the finishing high-pressure superheater 54 exceeds a predetermined value.

In addition, exhaust from the high-pressure section 30 of the steam turbine 22 may be directed into a primary re-heater 58 and a secondary re-heater 60 where it may be re-heated before being directed into the intermediate-pressure section 28 of the steam turbine 22. The primary re-heater 58 and secondary re-heater 60 may also be associated with an inter-stage attemperator 62 for controlling the exhaust steam temperature from the re-heaters. Specifically, the inter-stage attemperator 62 may be configured to control the temperature of steam exiting the secondary re-heater 60 by injecting cooler feedwater spray into the superheated steam upstream of the secondary re-heater 60 whenever the exhaust temperature of the steam exiting the secondary re-heater 60 exceeds a predetermined value.

In combined cycle systems such as system 10, hot exhaust gas 34 may flow from the gas turbine 12 and pass through the HRSG 32 and may be used to generate high-pressure, high-temperature steam. The steam produced by the HRSG 32 may then be passed through the steam turbine 22 for power generation. In addition, the produced steam may also be supplied to any other processes where superheated steam may be used. The gas turbine 12 cycle is often referred to as the “topping cycle,” whereas the steam turbine 22 generation cycle is often referred to as the “bottoming cycle.” By combining these two cycles as illustrated in FIG. 1, the combined cycle power generation system 10 may lead to greater efficiencies in both cycles. In particular, exhaust heat from the topping cycle may be captured and used to generate steam for use in the bottoming cycle.

The gas turbine 12 may be operated using fuel from a fuel system 64. In particular, the fuel system 64 may supply the gas turbine 12 with fuel 66, which may be burned within the combustion chamber 18 of the gas turbine 12. Although natural gas may be a preferred fuel for use within the combustion chamber 18 of the gas turbine 12, any suitable fuel 66 may be used. The fuel system 64 may generate fuel 66 for use within the gas turbine 12 in various ways. In certain exemplary embodiments, the fuel system 64 may generate fuel 66 from other hydrocarbon resources. For example, the fuel system 64 may include a coal gasification process, wherein a gasifier breaks down coal chemically due to interaction with steam and the high pressure and temperature within the gasifier. From this process, the gasifier may produce a fuel 66 of primarily CO and H₂. This fuel 66 is often referred to as “syngas” and may be burned, much like natural gas, within the combustion chamber 18 of the gas turbine 12.

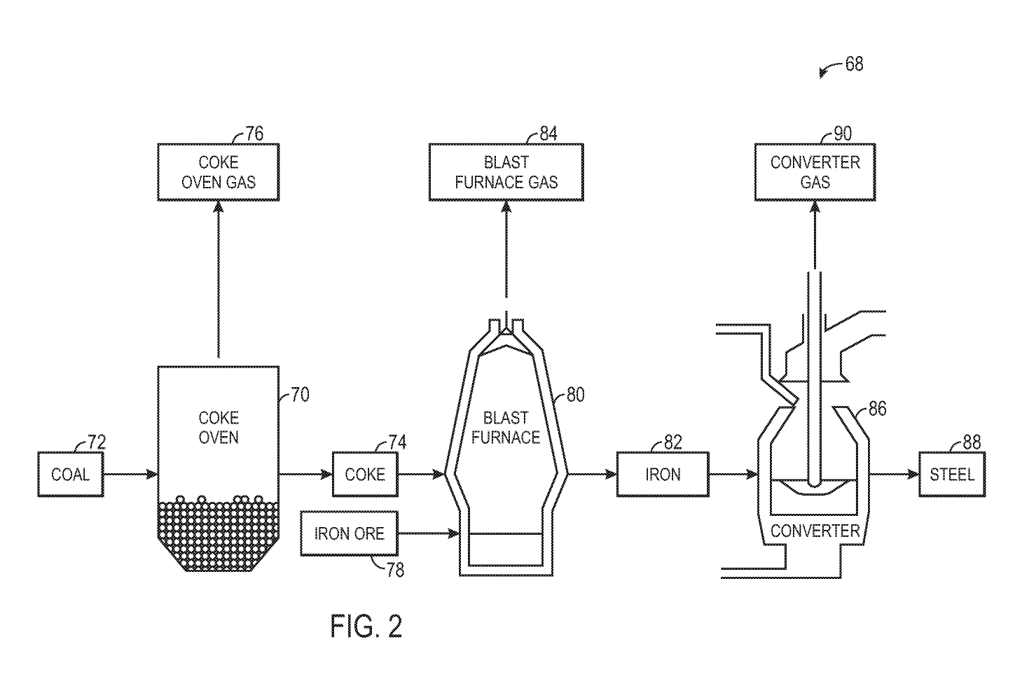

However, in other exemplary embodiments, the fuel system 64 may receive and further process fuel sources from other processes to generate the fuel 66 used by the gas turbine 12. For example, in certain exemplary embodiments, the fuel system 64 may receive fuel sources generated by a steel mill. FIG. 2 is a process flow diagram of an exemplary embodiment of a steel mill 68 which may generate fuel sources for use within the fuel system 64. Steel production processes of the steel mill 68 typically generate large volumes of specialty gases as by-products. The exemplary embodiment associated with a steel mill 68 is not intended to limit the invention in any manner, but is merely intended to describe one exemplary aspect of the system as embodied by the invention.

For instance, as illustrated in FIG. 2, there are at least three main process stages in the production of steel, all of which generate gases. In particular, a coke oven 70 may receive coal 72, such as pit coal, and produce coke 74 using dry distillation of the coal 72 in the absence of oxygen. Coke oven gas 76 may also be generated as a by-product of the process for producing coke 74 within the coke oven 70. Next, the coke 74 produced by the coke oven 70, as well as iron ore 78, may be directed into a blast furnace 80. Metal iron 82 may be produced within the blast furnace 80. In addition, blast furnace gas 84 may be generated as a by-product of the blast furnace 80. The iron 82 produced by the blast furnace 80 may then be directed into a converter 86, within which the iron 82 may be refined into steel 88 with oxygen and air. In addition, converter gas 90 may be generated as a by-product of the process for producing steel 88 within the converter 86.

Therefore, the steel mill 68 may generate three separate by-product gases, e.g., the coke oven gas 76, the blast furnace gas 84, and the converter gas 90, all of which may be characterized by different chemical compositions and properties. For example, the coke oven gas 76 may generally be comprised of approximately 50-70% hydrogen (H₂) and approximately 25-30% methane (CH₄) and may have a lower heating value (LHV) of approximately 4,250 kcal/Nm³. Conversely, the blast furnace gas 84 may generally be comprised of approximately 5% hydrogen and approximately 20% carbon monoxide (CO) and may have an LHV of only approximately 700 kcal/Nm³. In addition, the converter gas 90 may generally be comprised of approximately 60+% carbon monoxide and may have an LHV of approximately 2,500 kcal/Nm³. As such, the blast furnace gas 84 may have a considerably lower LHV than both the coke oven gas 76 and the converter gas 90. However, in certain exemplary embodiments, the fuel system 64 may blend the coke oven gas 76, the blast furnace gas 84, and the converter gas 90 to generate a fuel 66 meeting minimum and maximum acceptable LHV thresholds for the gas turbine 12.

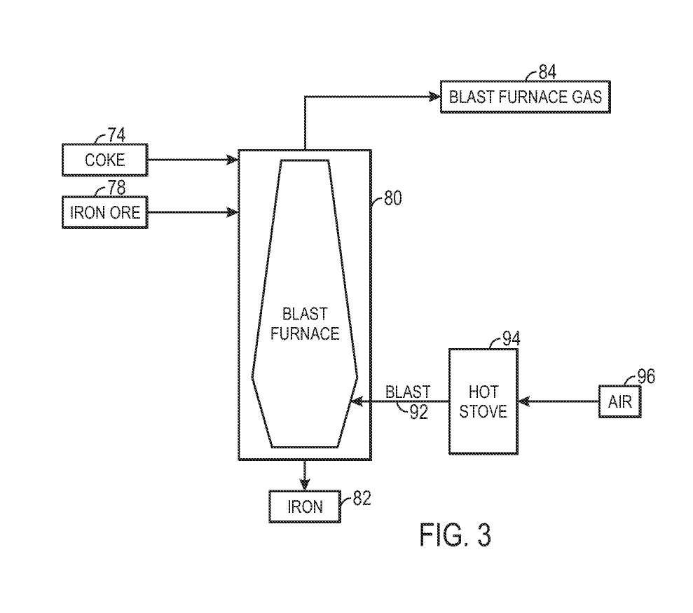

To make the iron 82 from the iron ore 78, air is heated to a very high temperature and then introduced into the bottom of the blast furnace 80. The heated air may be referred to as hot blast. When the hot blast comes into contact with the iron ore 78 and the coke 74 inside the blast furnace 80, the iron oxide is reduced to metal iron 82. FIG. 3 is a schematic flow diagram of an exemplary embodiment of a blast furnace 80 of FIG. 2. As illustrated, in certain exemplary embodiments, hot blast 92 may be delivered to the blast furnace 80 from a hot stove 94. Air 96 may be heated within the hot stove 94 to produce the hot blast 92, which may be used in the blast furnace 80 to convert the iron ore 78 and coke 74 into metal iron 82. However, using the hot stove 94 may not be the most efficient method of producing the hot blast 92. For example, hot stoves have a tendency to foul, which may result in reduced reliability or in added costs to compensate for the reduced reliability with redundant systems.

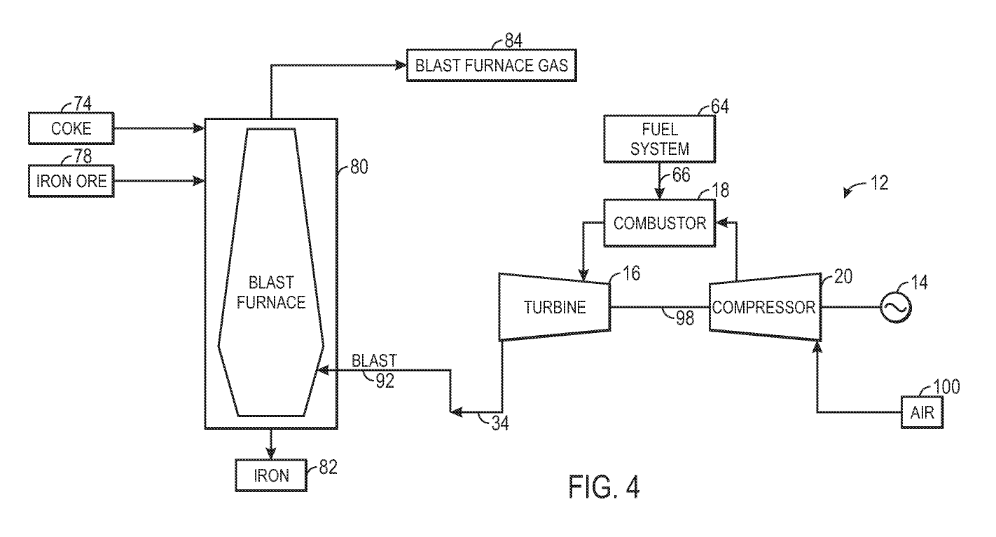

Another source of the hot blast 92 may be the combined cycle power generation system 10 of FIG. 1. More specifically, in certain exemplary embodiments, the gas turbine 12 of the system 10 of FIG. 1 may be used as the source of hot blast 92. For example, FIG. 4 is a schematic flow diagram of an exemplary embodiment of the blast furnace 80 of FIG. 2 configured to receive heated exhaust gas 34 directly from the turbine 16 of the gas turbine 12 of FIG. 1 as hot blast 92. As described above, the gas turbine 12 may use liquid or gas fuel, such as natural gas and/or a hydrogen rich synthetic gas. Fuel nozzles may intake the fuel 66, mix the fuel 66 with air, and distribute the air-fuel mixture into the combustor 18. For example, the fuel nozzles may inject the air-fuel mixture into the combustor 18 in a suitable ratio for optimal combustion, emissions, fuel consumption, and power output. The air-fuel mixture combusts in a chamber within the combustor 18, thereby creating hot pressurized exhaust gases.

The combustor 18 directs the heated exhaust gas 34 through the turbine 16 toward an exhaust outlet. As the heated exhaust gas 34 passes through the turbine 16, the gases force one or more turbine blades to rotate a shaft 98 along an axis of the gas turbine 12. The shaft 98 may be connected to various components of the gas turbine 12, including the compressor 20. The compressor 20 also includes blades that may be coupled to the shaft 98. As the shaft 98 rotates, the blades within the compressor 20 also rotate, thereby compressing air 100 from an air intake through the compressor 20 and into the combustor 18. The shaft 98 may also be connected either mechanically or aerodynamically to the load 14, which may be a stationary load, such as an electrical generator in a power plant. The load 14 may include any suitable device capable of being powered by the rotational output of the gas turbine 12. As illustrated, the heated exhaust gas 34 from the turbine 16 of the gas turbine 12 may be delivered directly to the blast furnace 80 as hot blast 92. In other words, the heated exhaust gas 34 may be delivered to the blast furnace 80 without first being directed into a hot stove.

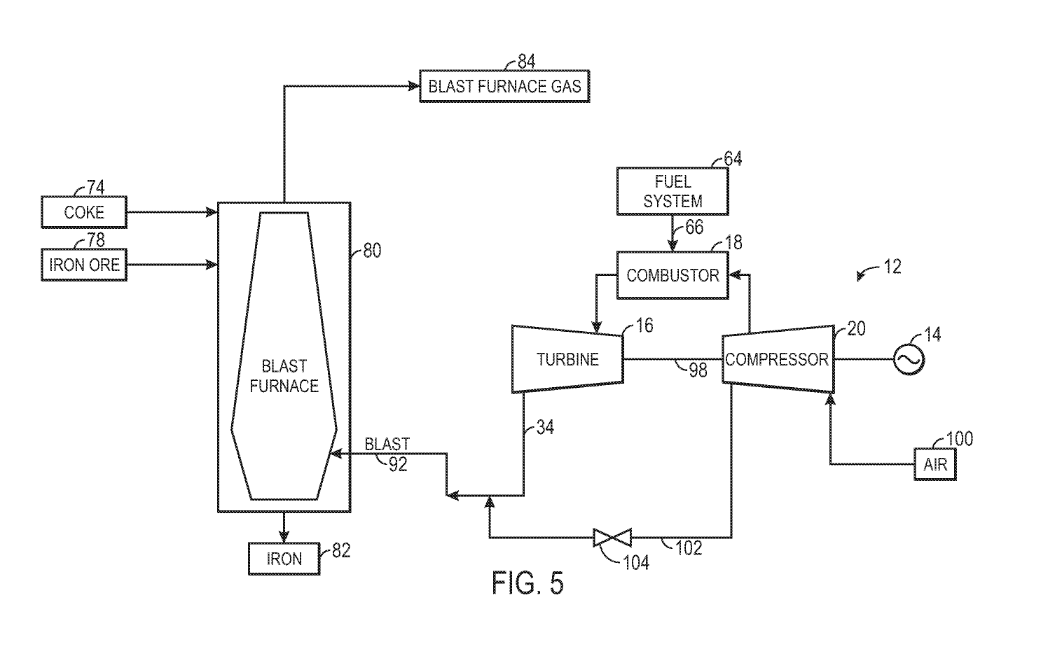

However, the heated exhaust gas 34 from the turbine 16 of the gas turbine 12 of FIG. 1 may not be the only source of hot blast 92 for use in the blast furnace 80. For example, FIG. 5 is a schematic flow diagram of an exemplary embodiment of the blast furnace 80 of FIG. 2 configured to receive heated exhaust gas 34 directly from the turbine 16 of the gas turbine 12 of FIG. 1 and hot extraction air 102 directly from the compressor 20 of the gas turbine 12 of FIG. 1 as hot blast 92. In certain applications, the gas turbine 12 pressure ratio may approach a limit for the compressor 20. For instance, in applications where low-BTU fuels are used as fuel sources in the combustor 18, or in locations characterized by lower ambient temperatures, the compressor 20 pressure ratio (e.g., the ratio of the air pressure exiting the compressor 20 relative to the air pressure entering the compressor 20) may become lower than the turbine 16 pressure ratio (e.g., the ratio of the hot gas pressure exiting the turbine 16 relative to the hot gas pressure entering the turbine 16). In order to provide compressor 20 pressure ratio protection (e.g., reduce the possibility of stalling the compressor 20), air discharged from the compressor 20 may be bled off as hot extraction air 102 via an overboard bleed air line, for example.

The amount of hot extraction air 102 bled from the compressor 20 may be a function of ambient conditions and the gas turbine 12 output. More specifically, the amount of hot extraction air 102 bled may increase with lower ambient temperatures and lower gas turbine 12 loads. In addition, in gas turbine 12 applications utilizing low-BTU fuel 66, the flow rate of the fuel 66 will generally be much higher than in comparable natural gas fuel applications. This is primarily due to the fact that more low-BTU fuel is used in order to attain comparable heating or a desired firing temperature. As such, additional backpressure may be exerted on the compressor 20. In these applications, the air discharged from the compressor 20 may also be bled to reduce the backpressure and improve the stall margin (e.g., margin of design error for preventing stalling) of the compressor 20.

Bleeding compressed air discharged from the compressor 20 may decrease the net efficiency of the combined cycle power generation system 10, because the energy expended to raise the pressure of the inlet air 100 within the compressor 20 may not be recovered by the combustor 18 and turbine 16 of the gas turbine 12. However, using the hot extraction air 102 bled from the compressor 20 as hot blast 92 may facilitate recovery of the energy in the hot extraction air 102 that may otherwise be lost. As illustrated in FIG. 5, the hot extraction air 102 from the compressor 20 of the gas turbine 12 may be delivered directly to the blast furnace 80 as hot blast 92. In other words, the hot extraction air 102 may be delivered to the blast furnace 80 without first being directed into a hot stove. In certain exemplary embodiments, a flow control valve 104 may be used to control the flow of the hot extraction air 102 bled from the compressor 20 of the gas turbine 12.

More specifically, the hot exhaust gas 34 from the turbine 16 of the gas turbine 12 and the hot extraction air 102 bled from the compressor 20 of the gas turbine 12 may be combined as hot blast 92 for the blast furnace 80. As illustrated, in certain exemplary embodiments, the heated exhaust gas 34 and the hot extraction air 102 may be combined into a single stream of hot blast 92 upstream of the blast furnace 80. However, in other exemplary embodiments, the heated exhaust gas 34 and the hot extraction air 102 may both be directed into the blast furnace 80 as individual streams of hot blast 92. In certain exemplary embodiments, the flow control valve 104 may be used to control the mixing of the heated exhaust gas 34 and the hot extraction air 102 upstream of the blast furnace.

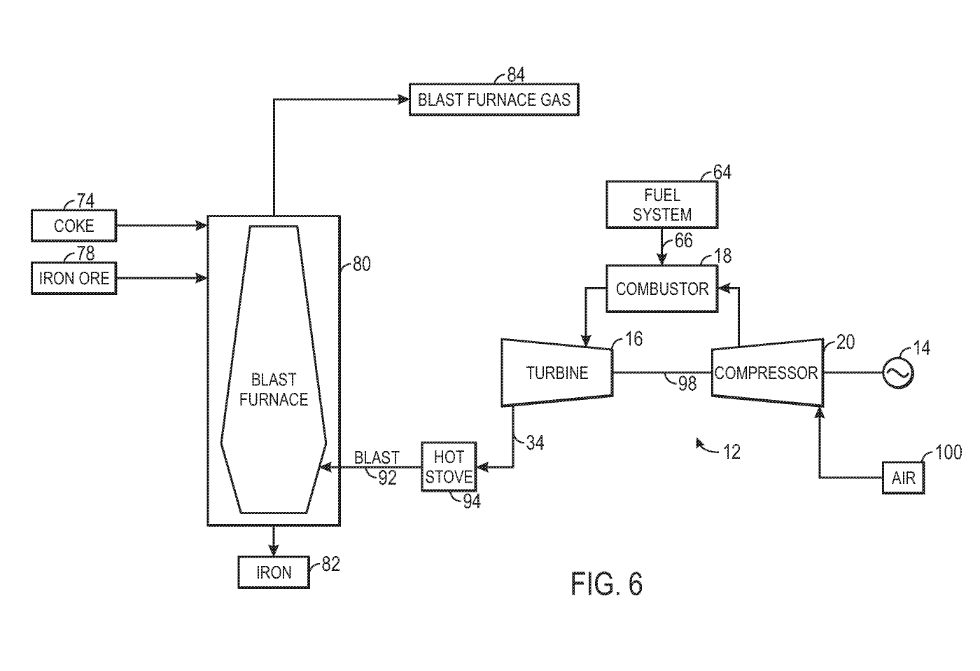

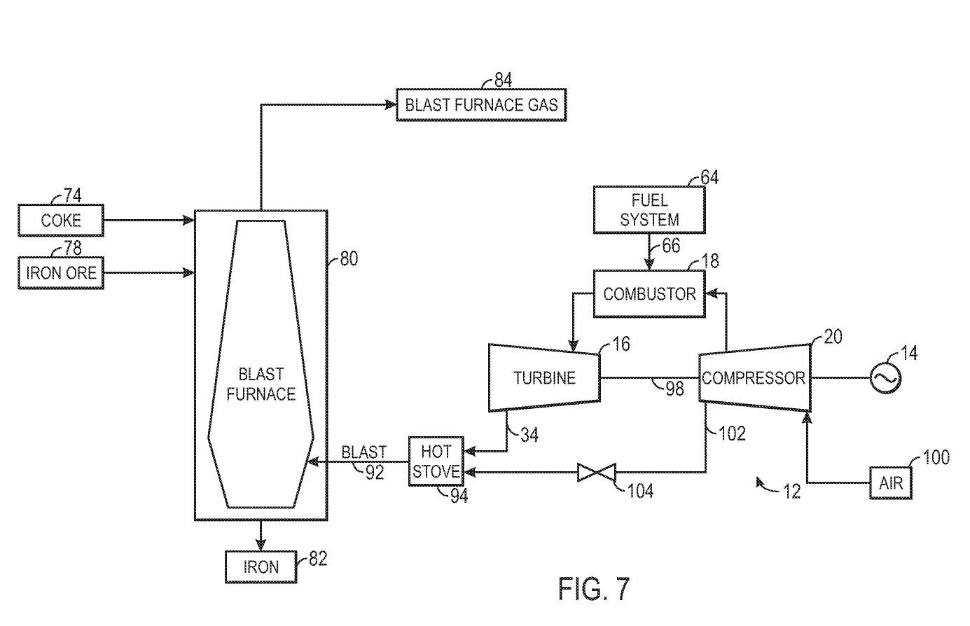

Instead of feeding the exhaust gas 34 from the turbine 16 of the gas turbine 12 and the hot extraction air 102 from the compressor 20 of the gas turbine 12 directly into the blast furnace 80 as hot blast 92, in certain exemplary embodiments, these sources of hot blast heat may first be directed into a hot stove 94. For example, FIG. 6 is a schematic flow diagram of an exemplary embodiment of the blast furnace 80 of FIG. 2 configured to receive hot blast 92 from the hot stove 94, wherein the hot stove 94 is configured to produce the hot blast 92 from heated exhaust gas 34 received from the turbine 16 of the gas turbine 12 of FIG. 1. In addition, FIG. 7 is a schematic flow diagram of an exemplary embodiment of the blast furnace 80 of FIG. 2 configured to receive hot blast 92 from the hot stove 94, wherein the hot stove 94 is configured to produce the hot blast 92 from heated exhaust gas 34 received from the turbine 16 of the gas turbine 12 of FIG. 1 and hot extraction air 102 received from the compressor 20 of the gas turbine 12 of FIG. 1.

Each of the exemplary embodiments of FIGS. 6 and 7 are similar to the embodiments of FIGS. 4 and 5, respectively. However, in the embodiments illustrated in FIGS. 6 and 7, the heated exhaust gas 34 and the hot extraction air 102 are first directed into the hot stove 94, instead of being fed directly into the blast furnace 80 as hot blast 92. The hot stove 94 in the embodiments of FIGS. 6 and 7 uses the heated exhaust gas 34 and the hot extraction air 102 as sources of hot blast heat to produce the hot blast 92, which is directed into the blast furnace 80.

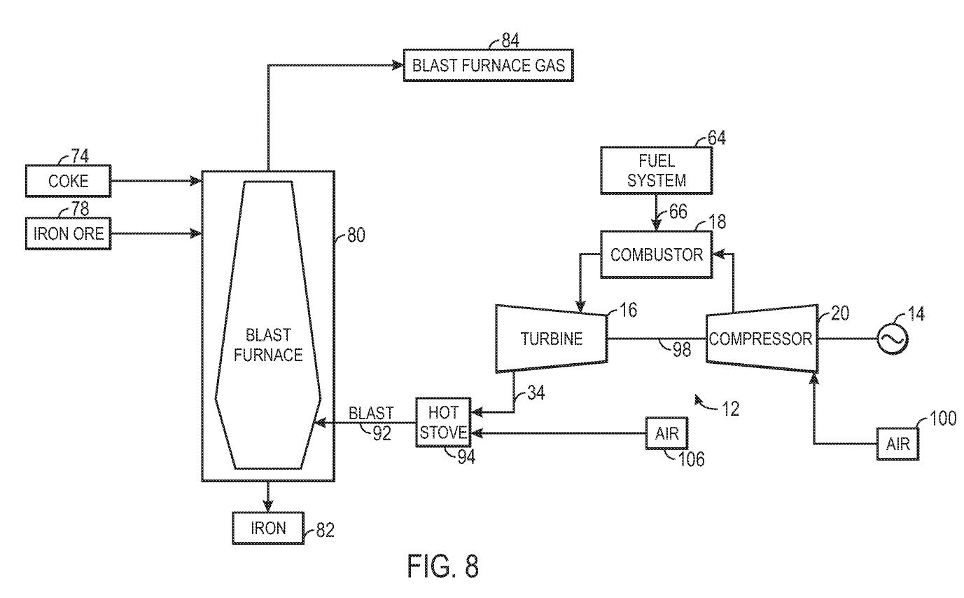

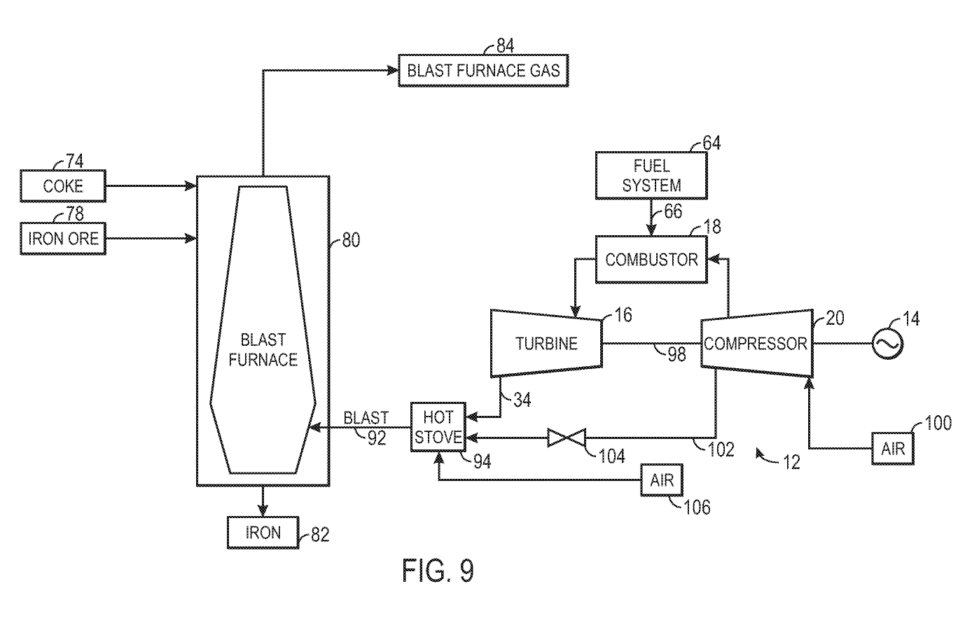

In each of the exemplary embodiments illustrated in FIGS. 6 and 7, the heated exhaust gas 34 from the turbine 16 of the gas turbine 12 and the hot extraction air 102 from the compressor 20 of the gas turbine 12 are the only sources of hot blast heat used for production of the hot blast 92 in the hot stove 94. However, in other exemplary embodiments, the heated exhaust gas 34 and the hot extraction air 102 may be supplemented by ambient air in the hot stove 94. For example, FIG. 8 is a schematic flow diagram of an exemplary embodiment of the blast furnace 80 of FIG. 2 configured to receive hot blast 92 from the hot stove 94, wherein the hot stove 94 is configured to produce the hot blast 92 from heated exhaust gas 34 received from the turbine 16 of the gas turbine 12 of FIG. 1 and supplemental ambient air 106. In addition, FIG. 9 is a schematic flow diagram of an exemplary embodiment of the blast furnace 80 of FIG. 2 configured to receive hot blast 92 from the hot stove 94, wherein the hot stove 94 is configured to produce the hot blast 92 from heated exhaust gas 34 received from the turbine 16 of the gas turbine 12 of FIG. 1, hot extraction air 102 received from the compressor 20 of the gas turbine 12 of FIG. 1, and supplemental ambient air 106.

Each of the exemplary embodiments of FIGS. 8 and 9 are similar to the embodiments of FIGS. 6 and 7, respectively. However, in the embodiments illustrated in FIGS. 8 and 9, the heated exhaust gas 34 and the hot extraction air 102 are supplemented as a hot blast heat source by the supplemental ambient air 106. The hot stove 94 in the embodiments of FIGS. 8 and 9 uses the heated exhaust gas 34 and the hot extraction air 102 as sources of hot blast heat to produce the hot blast 92, which is directed into the blast furnace 80. The ambient air 106 supplements the heated exhaust gas 34 and the hot extraction air 102.

Although the exemplary embodiments of FIGS. 4 through 9 illustrate the gas turbine engine 12 of the combined cycle power generation system 10 of FIG. 1 as the source of the hot blast 92 heat source (e.g., the heated exhaust gas 34 from the turbine 16 of the gas turbine 12 and the hot extraction air 102 from the compressor 20 of the gas turbine 12) for use in the blast furnace 80, other sources of hot blast heat from the combined cycle power generation system 10 of FIG. 1 may be used. For example, in certain exemplary embodiments, heat sources from the HRSG 32 may be used as a hot blast heat source. In addition, in other exemplary embodiments, the gas turbine used as a source of hot blast heat may not be the gas turbine 12 of the combined cycle power generation system 10 of FIG. 1. Rather, the gas turbine used as the source of hot blast heat may be any suitable gas turbine, such as a simple cycle gas turbine, which may not be associated with a combined cycle power generation system.

In the exemplary embodiments illustrated in FIGS. 4 through 9, the source of the fuel 66 directed into the combustor 18 of the gas turbine 12 may be any suitable liquid and/or gaseous fuel source. However, in certain exemplary embodiments, the blast furnace gas 84 from the blast furnace 80 may be used as a source of the fuel 66 combusted in the combustor 18 of the gas turbine 12. Indeed, in certain exemplary embodiments, the coke oven gas 76 and the converter gas 90 from the steel mill 68 of FIG. 2 may also be used as sources of the fuel 66. More specifically, in exemplary certain embodiments, the blast furnace gas 84 and/or the coke oven gas 76 and/or the converter gas 90 from the steel mill 68 of FIG. 2 may be blended by the fuel system 64 to produce the fuel 66, which is directed into the combustor 18 of the gas turbine 12.

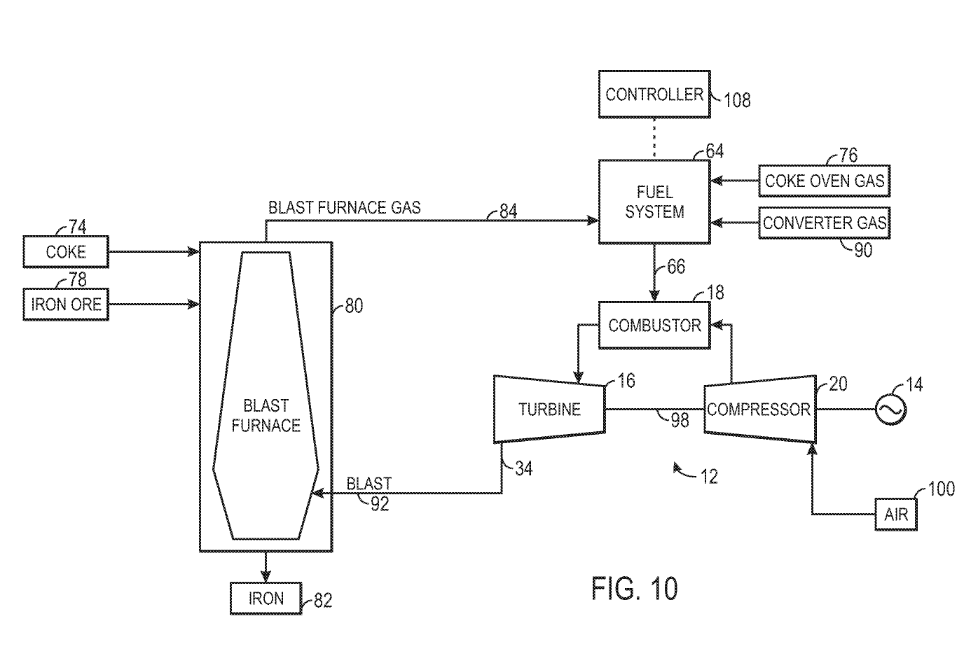

For example, FIG. 10 is a schematic flow diagram of an exemplary embodiment of the blast furnace 80 of FIG. 2 configured to receive heated exhaust gas 34 directly from the turbine 16 of the gas turbine 12 of FIG. 1 as hot blast 92, wherein the combustor 18 of the gas turbine 12 uses fuel 66 from the steel mill 68 of FIG. 2. The embodiment illustrated in FIG. 10 utilizes the blast furnace gas 84 and/or the coke oven gas 76 and/or the converter gas 90 from the steel mill 68 of FIG. 2 as sources of the fuel 66 produced by the fuel system 64. In certain exemplary embodiments, the blast furnace gas 84 and/or the coke oven gas 76 and/or the converter gas 90 from the steel mill 68 of FIG. 2 may be blended by the fuel system 64 to produce a fuel 66 with certain desired properties.

For example, in certain exemplary embodiments, some of the steel mill by-product gases (e.g., the blast furnace gas 84) may be characterized by lower heating values than typical fuels while the other steel mill by-product gases (e.g., the coke oven gas 76) may be characterized by a higher heating values than typical fuels. However, the gases with the lower heating values (e.g., the blast furnace gas 84) may be available in significantly larger quantities than the gases with the higher heating values (e.g., the coke oven gas 76). Therefore, in order to generate the fuel 66 suitable for combustion within the combustor 18 of the gas turbine 12, the heating value of the blended fuel 66 (e.g., from blending the blast furnace gas 84 and the coke oven gas 76) may be controlled and maintained above a certain predetermined target level at all times during operation. In other exemplary embodiments, other properties (e.g., pressure, temperature, and so forth) of the blended fuel 66 may be controlled and maintained.

In certain exemplary embodiments, a controller 108 may be used to control the blending of the blast furnace gas 84, the coke oven gas 76, and the converter gas 90. For instance, the controller 108 may be configured to determine appropriate blending ratios of the blast furnace gas 84, the coke oven gas 76, and the converter gas 90 based on availability of each gas stream, properties of each gas stream (e.g., measured by calorimeters, gas chromatographs, and so forth), and other operating variables. For example, in certain exemplary embodiments, an aspect of the controller 108 may be to ensure that a substantially constant lower heating value of the blended fuel 66 from the fuel system 64 is maintained. In other words, the lower heating value of the blended fuel 66 from the fuel system 64 may be maintained within a range that varies only by a small amount (e.g., approximately 1, 2, 3, 4, or 5 percent). By doing so, the operation of the gas turbine 12, as well as the fuel system 64 and other associated equipment, may be held substantially constant, regardless of operating conditions.

In certain exemplary embodiments, the controller 108 may include a memory, such as any suitable type of non-volatile memory, volatile memory, or combination thereof. The memory may include code/logic for performing any of the control functions described herein. Furthermore, the code/logic may be implemented in hardware, software (such as code stored on a tangible machine-readable medium), or a combination thereof.

The exemplary embodiment illustrated in FIG. 10 is similar to the embodiment illustrated in FIG. 4, except that the gas by-products from the steel mill 68 are used as fuel sources in the fuel system 64. However, using the fuel system 64 to blend the blast furnace gas 84 and/or the coke oven gas 76 and/or the converter gas 90 and using the controller 108 to control the blending of the blast furnace gas 84 and/or the coke oven gas 76 and/or the converter gas 90 may be implemented in any of the embodiments disclosed herein.

To implement the embodiments illustrated in FIGS. 4 through 9, certain adjustments to the gas turbine 12 may be made. For example, in certain exemplary embodiments, the pressure and temperature of the heated exhaust gas 34 from the turbine 16 of the gas turbine 12 may be lower than required by the blast furnace 80. One approach for increasing the pressure and temperature of the heated exhaust gas 34 from the turbine 16 may be to remove one or more blades from the turbine 16 to match the pressure needed by the blast furnace 80. In addition, in certain exemplary embodiments, heat exchangers and expanders may be used to increase the temperature and decrease the pressure of the hot blast 92 before introducing the hot blast 92 into the blast furnace 80.

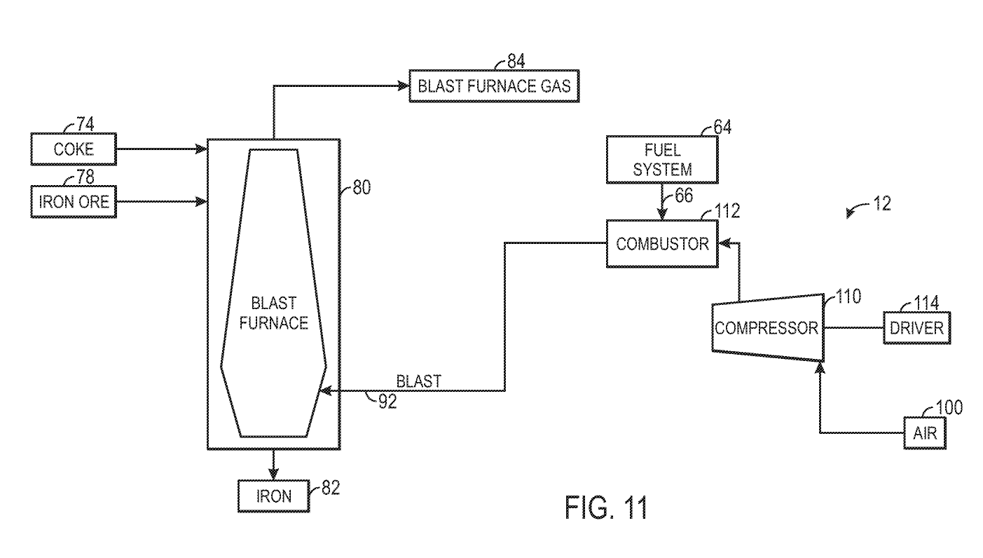

In other exemplary embodiments, a turbine of a gas turbine may not be used at all. Rather, only a compressor and a combustor may be used, instead of a gas turbine. For example, FIG. 11 is a schematic flow diagram of an exemplary embodiment of a compressor 110 and a combustor 112 configured to produce hot blast 92 for use in the blast furnace 80 of FIG. 2. The compressor 110 may be designed to match the pressure required by the blast furnace 80. Compressed air from the compressor 110 may be directed into the combustor 112, where the compressed air may be mixed with fuel and combusted to produce hot blast 92, which may be delivered directly to the blast furnace 80 from the combustor 112. The compressor 110 may be driven by a compressor driver 114, such as an electric motor, steam turbine, gas turbine, gas engine, or any other suitable driver.

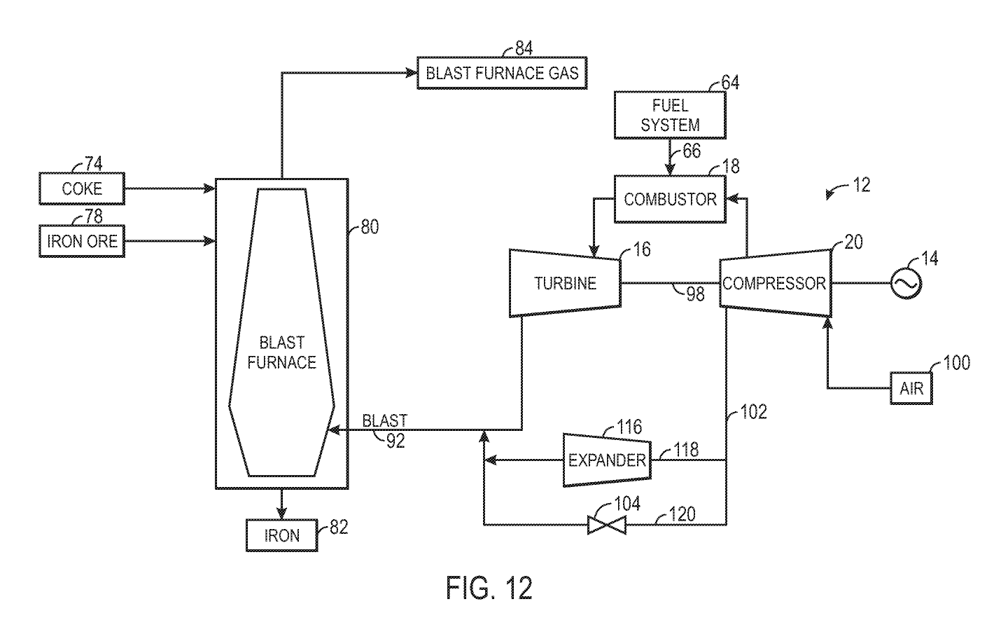

As described above, expanders may be used to decrease the pressure of the hot blast 92 before introducing the hot blast 92 into the blast furnace 80. For example, FIG. 12 is a schematic flow diagram of an exemplary embodiment of the blast furnace 80 of FIG. 2 configured to receive hot extraction air 102 from the compressor 20 of the gas turbine 12 of FIG. 1 and through an expander 116. As illustrated, the hot extraction air 102 from the compressor 20 of the gas turbine 12 may be split into a first air stream 118 and a second air stream 120. The first air stream 118 may be directed into the expander 116, where the pressure of the first air stream 118 is decreased, while the second air stream 120 bypasses the expander 116 through the flow control valve 104. The first and second air streams 118, 120 may then be combined into one stream to form the hot blast 92. In certain exemplary embodiments, the bypass line through the flow control valve 104 may not be used. Although illustrated as a modification to the exemplary embodiment illustrated in FIG. 5, the expander 116 may be used with any of the exemplary embodiments described herein to reduce the pressure of the hot blast 92 before it is introduced into the blast furnace 80.

Using heated gas or air from turbine and/or compressor components (e.g., heated exhaust gas 34 from the turbine 16 of the gas turbine 12 and hot extraction air 102 from the compressor 20 of the gas turbine 12) as hot blast 92 in the blast furnace 80 may provide several benefits. For example, as described above, hot stoves have a tendency to foul over time. Therefore, using the heated exhaust gas 34 from the turbine 16 of the gas turbine 12 and the hot extraction air 102 from the compressor 20 of the gas turbine 12 may reduce or even eliminate the load on the hot stove 94, thereby increasing the reliability of the blast furnace 80 operation, as well as reducing maintenance costs associated with the hot stove 94. As such, the overall efficiency of the steel mill 68 may be increased at a lower overall cost. The disclosed embodiments may also be a more cost effective way of producing large quantities of hot, compressed air.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a gas turbine system having a turbine, combustor, and a compressor;
an output flow path from the gas turbine system; and
a blast furnace coupled to the output flow path, wherein output flow path is configured to deliver heated air or exhaust gas from the gas turbine system directly to the blast furnace as a blast heat source.

2. The system of claim 1, wherein the output flow path is coupled to the turbine of the gas turbine system, and the output flow path is configured to deliver the exhaust gas from the turbine directly to the blast furnace as the blast heat source.

3. The system of claim 1, wherein the output flow path is coupled to the turbine and the compressor of the gas turbine system, the output flow path is configured to deliver the exhaust gas from the turbine directly to the blast furnace as a first portion of the blast heat source, and the output flow path is configured to deliver the heated air from the compressor directly to the blast furnace as a second portion of the blast heat source.

4. The system of claim 1, comprising a fuel system configured to deliver a fuel to the combustor of the gas turbine system, wherein the fuel system is configured to receive the fuel at least partially from the blast furnace as blast furnace gas.

5. The system of claim 4, wherein the fuel system is configured to receive the fuel at least partially as a coke oven gas from a coke oven, a converter gas from a converter, or a combination thereof.

6. The system of claim 5, comprising a controller configured to control blending of the blast furnace gas, coke over gas, and converter gas.

7. A system, comprising:
a gas turbine system having a turbine, combustor, and a compressor; and
a blast furnace configured to receive exhaust gas from the turbine of the gas turbine system as a first blast heat source.

8. The system of claim 7, wherein the system is configured to deliver the exhaust gas from the turbine directly to the blast furnace as the first blast heat source.

9. The system of claim 8, wherein the system is configured to deliver heated air from the compressor of the gas turbine system directly to the blast furnace as a second blast heat source.

10. The system of claim 9, comprising a heat exchanger upstream of the blast furnace, wherein the heat exchanger is configured to increase a temperature of the heated air from the compressor of the gas turbine system.

11. The system of claim 9, comprising an expander upstream of the blast furnace, wherein the expander is configured to decrease the pressure of the heated air from the compressor of the gas turbine system.

12. The system of claim 7, comprising a hot stove, wherein the system is configured to deliver the exhaust gas from the turbine to the hot stove as the first blast heat source, and the hot stove is configured to convert the exhaust gas from the turbine into blast air for delivery to the blast furnace.

13. The system of claim 12, wherein the system is configured to deliver heated air from the compressor of the gas turbine system to the hot stove as a second blast heat source, and the hot stove is configured to convert the heated air from the compressor into blast air for delivery to the blast furnace.

14. The system of claim 13, wherein the system is configured to deliver supplemental air to the hot stove as a third blast heat source, and the hot stove is configured to convert the supplemental air into blast air for delivery to the blast furnace.

15. The system of claim 7, comprising a fuel system configured to deliver a fuel to the combustor of the gas turbine system, wherein the fuel system is configured to receive the fuel at least partially from the blast furnace as blast furnace gas.

16. The system of claim 15, wherein the fuel system is configured to receive the fuel at least partially as a coke oven gas from a coke oven, a converter gas from a converter, or a combination thereof.

17. A system, comprising:
a fuel system configured to produce a fuel;
a compressor configured to produce compressed air;
a combustor configured to combust the compressed air from the compressor and the fuel from the fuel system; and
a blast furnace configured to receive exhaust gas from the combustor as a blast heat source.

18. The system of claim 17, wherein the fuel comprises blast furnace gas from the blast furnace.

19. The system of claim 18, wherein the fuel comprises coke oven gas from a coke oven, converter gas from a converter, or a combination thereof

20. The system of claim 19, comprising a controller configured to control blending of the blast furnace gas, coke over gas, and converter gas.
